(19) United States
(12) Patent Application Publication
(10) Pub. No.: US 2016/0379278 A9
(43) Pub. Date: Dec. 29, 2016

(54) MULTI-COMPONENT MARKETING PLATFORM FOR THE PRODUCTION OF COMBINATION VIDEO PACKAGES WITH BRANDED MARKET VIDEOS AND PROFESSIONALLY PRODUCED CONSUMER CONTENT

(71) Applicant: VScreen, Inc., Orlando, FL (US)

(72) Inventor: Stephen Schweickart, Indianapolis, IN (US)

(73) Assignee: VScreen, Inc., Orlando, FL (US)

(21) Appl. No.: 14/243,836

(22) Filed: Apr. 2, 2014

Related U.S. Application Data
(60) Provisional application No. 61/771,983, filed on Mar. 4, 2013.

(51) Int. Cl. G06Q 30/02

(52) U.S. Cl. CPC G06Q 30/0276

(57) ABSTRACT

A new and useful multi-component marketing platform for the production of combination video packages with branded market videos and professionally produced consumer content that allows a user to create custom and personalized marketing videos as informed by a particular industry or profession. The advantages of this invention over the existing art include functionality to brand the video to the user with assets such as video pre-roll, post-roll, changeable color scheme, and personal information, such as head-shot, logos, and contact information, the ability for the user to share resultant video content on the user's detail, social media, or other websites, and a delivery method for branded video newsletters specific to the user for marketing purposes such as sharing content and driving traffic to agent affiliated websites.

### REFERENCE TO SEQUENCE LISTING, A TABLE, OR A COMPUTER PROGRAM LISTING COMPACT DISK APPENDIX

Not Applicable.

### TECHNICAL FIELD

This invention relates generally to a platform for creating marketing materials. More specifically this invention relates to a multi-component marketing platform for the production of combination video packages with branded market videos and professionally produced consumer content.

### BACKGROUND OF THE INVENTION

The production of quality video for the purposes of promotion and advertising has traditionally been a cumbersome and expensive exercise. It has historically entailed the employ of many people of various arts, including writers, videographers, editors, and musicians. The daunting logistics of the endeavor often caused a chilling effect and relegated its use to only those with extravagant marketing and advertising budgets. With the advent of the internet, the need for video marketing only expanded as dissemination of information and distribution of marketing material became democratized and obtainable for even small business owners. However, improvements in the art of high-quality professional video production did not equally progress. There was no substitute for professional production and so the need for innovation was long felt.

In the applicant's experience, there is a need for a multi-component marketing platform for the production of combination video packages with branded market videos and professionally produced consumer content that allows a user to easily create custom and personalized marketing videos as informed by a particular industry or profession which has the i) functionality to brand the video to the user with assets such as video pre-roll, post-roll, changeable color scheme, and personal information, such as head-shot, logos, and contact information, ii) the ability for the user to share resultant video content on the user's detail, social media, or other websites, and iii) a delivery method for branded video newsletters specific to the user for marketing purposes such as sharing content and driving traffic to user affiliated websites.

### SUMMARY OF THE INVENTION

The present invention provides a new and useful multi-component marketing platform for the production of combination video packages with branded market videos and professionally produced consumer content that allows a user to create custom and personalized marketing videos as informed by a particular industry or profession. The advantages of this invention over the existing art include: i) functionality to brand the video to the user with assets such as video pre-roll, post-roll, changeable color scheme, and personal information, such as head-shot, logos, contact information, etc. ii) the ability for the user to share resultant video content on the user's detail, social media, or other websites, and iii) a delivery method for branded video newsletters specific to the user for marketing purposes such as sharing content and driving traffic to user affiliated websites.

According the present invention the user can be any type of professional. For example, in one envisioned embodiment of the present invention the user may be a real estate agent. In the current art, real estate agents communicate with prospective buyers using largely static websites which show sale listings, professional credentials and contact information. In the inventors' experience, the current means for connecting with the buyer are outdated, inflexible and do not offer a dynamic multimedia platform for sharing information, trends and other data with the consumer. Further, the current art allows only limited customization and branding options for the user agent. In the current art, real-time generation of custom video is non-existent and a long-felt need.

In one embodiment of the present invention the user, in this case a real estate agent, connects with the market videos platform that is presented by a service provider or other portal—typically web-based. Upon reaching the platform the user is presented with a portal that implements a sleek and user friendly interface. The user then selects the desired practice area or specialty—which can be real estate. Next, the user enters personal identifiers, credentials, and contact information. This often includes name, phone number, email address, website URL, picture/logo. The user may also choose a color scheme based on personal preference or for presentation of consistent branding and dress.

Upon entry of and according to the above data and preferences, the platform responsively and dynamically creates a preview video utilizing pre-created assets that are held in a database. Said video is then presented to the user that includes the user-provided elements, branded pre-roll and optionally branded post-roll. The branded pre-roll and post-roll are created using the agent user provided information and then is added to the market video, consumer content if any and/or user-uploaded videos.

The user is then presented with an opportunity to purchase the resultant video for her use. The purchase schemas include a direct purchase option (i.e. cart, or “Buy It Now” functionality). In the alternative the user may also elect a subscription package for multiple videos over time—otherwise known as a bundle.

Next the platform delivers the video to the user according to several options. The delivery options include providing a link to an html page generated by the platform, an embed code for use on a user website, or a link to a downloadable file for posting onto video service providers like YouTube. Said link to html page can be mailed by the user to a target recipient or client and said embed code can be automatically refreshed remotely with new content over time.

In an alternative embodiment of the present invention an auto-syndication option may be utilized to allow the user to expand use of the market video which includes integration into affiliate franchise resources—wherein a franchise may be a company such as Century 21.

In an alternate embodiment of the present invention the platform may also optionally create a branded agent detail page for the user. Said page would be automatically populated with personal information and consumer content videos.

In an alternate embodiment of the present invention the platform may further comprise functionality to generate branded newsletters and dissemination of the same to a user client database.

In an alternate embodiment of the present invention, a user provided logo can be optionally provided for the purpose of presenting the logo as a watermark on platform generated content. Said content includes but is not limited to market videos, consumer content and user 100 uploaded content.

Thus the present invention provides a new and useful multi-component marketing platform for the production of combination video packages with branded market videos and professionally produced consumer content that allows a user to create custom and personalized marketing videos as informed by a particular industry or profession. The advantages of this invention over the existing art include: i) functionality to brand the video to the user with assets such as video pre-roll, post-roll, changeable color scheme, and personal information, such as head-shot, logos, and contact information, ii) the ability for the user to share resultant video content on the user's detail, social media, or other websites, and iii) a delivery method for branded video newsletters specific to the user for marketing purposes such as sharing content and driving traffic to agent affiliated websites.

Further features and objectives of the present invention will become apparent form the following detailed description and the accompanying drawings.

### BRIEF DESCRIPTION OF THE DRAWINGS

FIG. 1 is a general flow diagram view of the phases comprising a multi-component marketing platform for the production of combination video packages with branded market videos and professionally produced consumer content that allows a user to create custom and personalized marketing videos as informed by a particular industry or profession according to the present invention; and

FIG. 2 is a detail flow diagram view of the present invention.

### DETAILED DESCRIPTION OF THE INVENTION

As described above, the present invention provides a new and useful multi-component marketing platform for the production of combination video packages with branded market videos and professionally produced consumer content that allows a user to create custom and personalized marketing videos as informed by a particular industry or profession, for example real estate. The advantages of this invention over the existing art include functionality to brand the video to the user with assets such as video pre-roll, post-roll, changeable color scheme, and personal information, such as head-shot, logos, and contact information, the ability for the user to share resultant video content on the user's detail, social media, or other websites, and a delivery method for branded video newsletters specific to the user for marketing purposes such as sharing content and driving traffic to agent affiliated websites. The following description and accompanying drawings disclose at least one version of such a device.

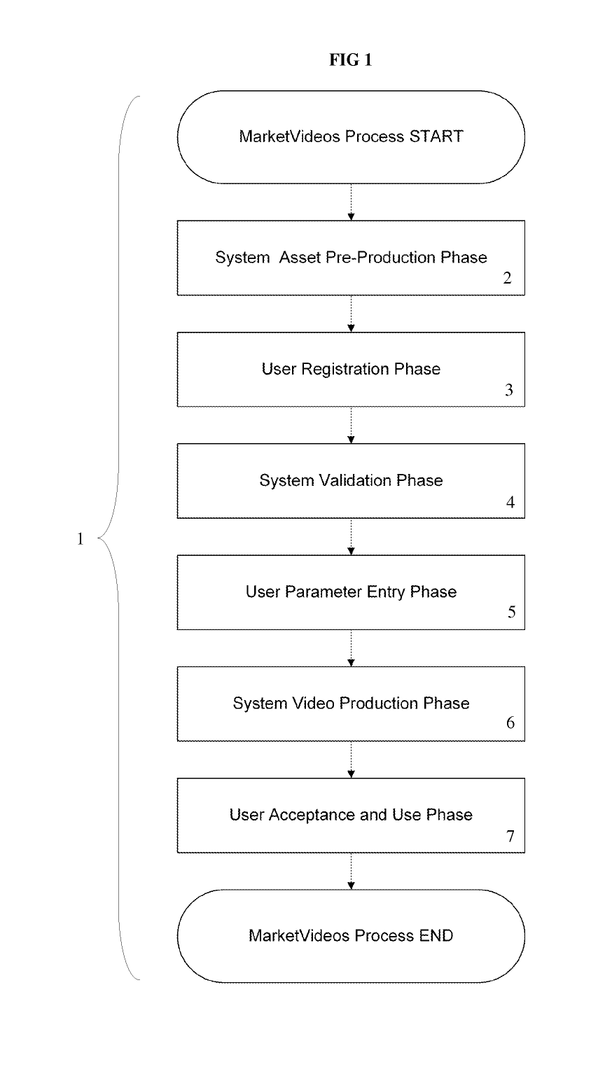

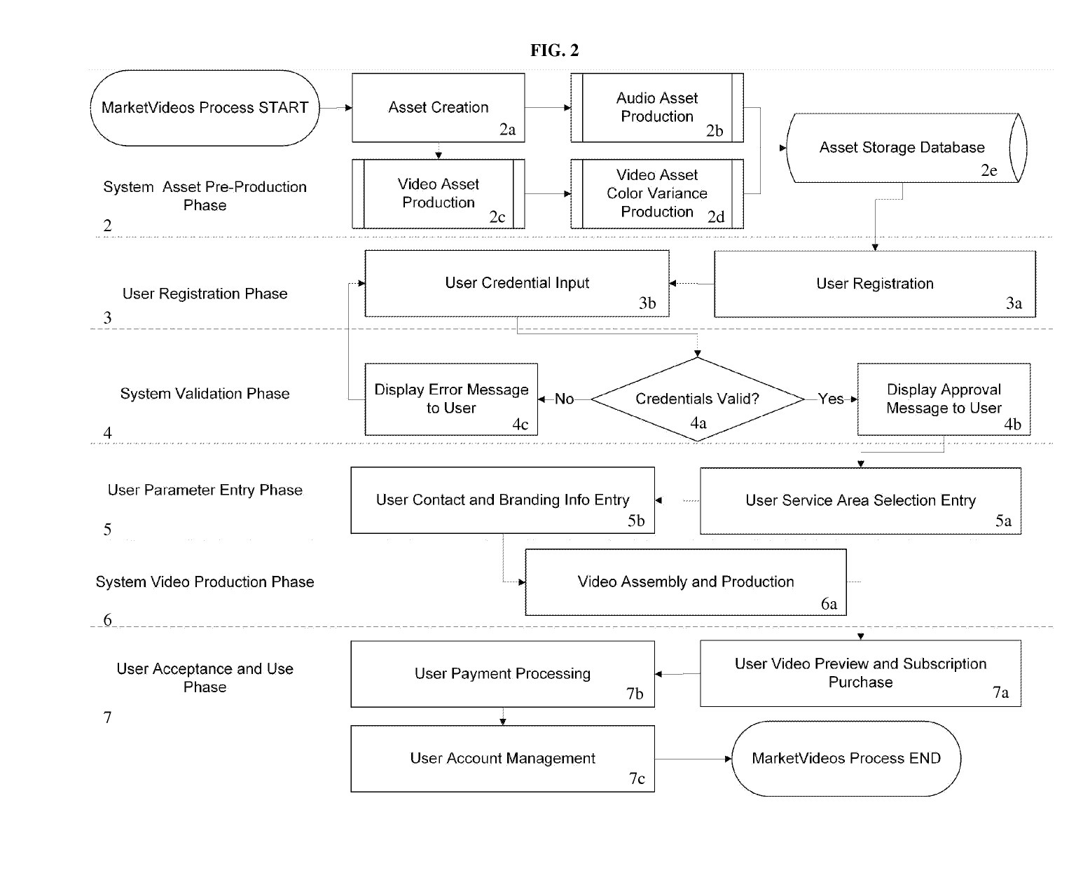

Referring now to the invention in FIG. 1 and FIG. 2, there is shown a multi-component marketing platform for the production of combination video packages with branded market videos and professionally produced consumer content shown generally 1 which comprises a system asset pre-production phase 2, a user registration phase 3 following the system asset pre-production phase 2, a system validation phase 4 following the user registration phase 3, a user parameter entry phase 5 following the system validation phase 4, a system video production phase 6 following the user parameter entry phase 5, and a user acceptance and use phase 7 following the system video production phase 6.

Referring now to FIG. 2 in more detail, the system asset pre-production phase 2 further comprises an asset creation process 2a, which includes a video asset production sub-process 2c and an audio asset production sub-process 2b. The said video asset production sub-process 2a includes shooting a plurality of videos and creation of a plurality of computer generated video assets that relate to various professional markets, for example shooting video relating home sales for use by users who are real estate agents. The scenes of the created video vary and are informed by the data available on a respective product, professional area or industry. Further, pre-production of the video scenes include “mock-ups” and storyboards created by graphic designers for approval. This can also include visual themes, elements, text, multiple color layouts and branding zones.

The said audio asset production sub-process 2b includes recording a plurality of scripted narrative and non-narrative audio files having a variety of data and conclusion options. Based upon the data metrics available to the system, a corresponding narrative segment is integrated into the resultant video. For example, if there is a decrease in inventory since a previous report, the system will select a scripted narrative audio segment that may report that early purchasers in the market received lower prices.

Once the video and audio assets are created, an asset storage database 2e receives and stores the created video and audio assets for later use. The storage database 2e can be any database, but in at least one embodiment of the invention, a database and production system named the “videolet system” was created with a single video template which can be regenerated instantly on demand using the information provided by the user, including color preferences, and other data metrics to create a branded market video with professionally produced content.

Next the user registration phase 3 follows the system asset pre-production phase 2, and is the first phase where the user interacts with the system—typically a web-based portal or website interface with a plurality of input fields, drop boxes, radio buttons and light boxes. The user registration phase 3 of the present invention comprises a user registration process 3a wherein the user provides identifying information including email address and password to create an account in the system. This identifying information is also used by the user to log onto and manage the account thereafter. A user credential input process 3b follows the user registration process 3a wherein the user provides identifying credentials that are specific to her professional field, for example entering MLS membership and ID in the case of a real estate agent. A plurality of auto-populating fields, selection buttons and input fields assist the user information input process, for example a “state” field that is pre-populated with US states expedites the process. Next the user registration phase 3 is followed by the system validation phase 4. This phase comprises a credentials valid determination 4a, wherein the identifying credentials provided by the user are validated by the system utilizing a protocol such as AJAX asynchronous JavaScript to query a public database to verify validity of said credentials, for example MLS membership and ID in the case of a real estate agent. If the result of the credential valid determination is affirmative, a display approval message to user process 4b follows. In the alternative, if the credentials valid determination result is negative, a display error message to the user process 4c follows. The system then returns the user to the user credential input process 3b of the user registration phase 3 to re-enter credentials.

The user parameter entry phase 5 follows upon completion of the system validation phase 4. The user parameter entry phase 5 comprises a user service area selection entry process 5a, which involves the user selection of a professional practice area or more narrow criteria of which they desire the resultant video content to include, for example home sale and market news in the case of a real estate agent or “Single Family or Condo/Townhome.” In order to narrow results, the system analyses other user provided input such as zip code to narrow options and result to the respective area.

A user contact and branding info entry process 5b follows the user service area selection 5a entry process. In this process, the user enters the contact information that is desired to be incorporated into the resultant video which may include name, phone number, email, and accreditations. The user then optionally uploads photos and branding images such as logos for incorporation into the resultant video. The upload can be accomplished in many ways, but in at least one embodiment, the upload, cropping and resizing of the photos is accomplished using a protocol such as AJAX asynchronous JavaScript.

In at least one embodiment of the present invention, certain data are required fields such as name, phone number and email.

In at least one embodiment of the present invention, the user is able to enter other data such as relevant accreditations, other website and custom information.

All of the user provided information, branding content and metric data collected by the system in the previous phases is merged into a single data feed which is sent to the videolet system to instantly create video with real time, up-to-date statistics and user provided information in the next phase.

Once the assets and user information is available and complete, the system begins the system video production phase 6a. In this phase a video assembly and production process 6a retrieves the data, video and audio assets from the asset storage database in the system asset pre-production phase of the current invention, and then merges the assets with the user provided information from the user parameter entry phase 5 to create a branded market video with professionally produced consumer content.

Further, the system asset pre-production phase 2 further comprises a video asset color variance production process 2d where video asset colors can be changed prior to video assembly and production process 6a according to the user selected preferences in the user parameter entry phase.

Finally, the system video production phase 6 is followed by the user acceptance and use phase 7. The user acceptance and use phase 7 comprises a user video preview and subscription purchase process 7a wherein the user previews the resultant video and optionally make changes to input parameters, preferences and any user controlled variables. Upon acceptance of the assembled video, which can be accomplished utilizing a “save video” button, a user payment processing process 7b follows the user video preview and subscription purchase process 7a. User payment processing process 7b involves the user providing payment information such as credit card information, which is later processed by a secure third party billing service. Further a user account management process 7c follows the user payment processing process 7b, which allows the user, optionally termed an “official subscriber,” to optionally and periodically update account information, send newsletters, obtain embed codes or links for videos, and download leads captured by the system for her use.

In an alternate embodiment of the present invention, the user payment processing process 7b further allows the user to select a plurality of videos and subscription services. In an alternate embodiment of the present invention the user payment processing process 7b accepts the entry of discount codes by the user.

In an alternate embodiment of the present invention, the system will access and utilize APIs (application programming interfaces) to accomplish various tasks, such as conducting MLS queries, validating MLS/Agent ID pairings, and regional data.

In an alternative embodiment of the present invention an auto-syndication option may be utilized to allow the user to expand use of the market video which includes integration into affiliate franchise resources—wherein a franchise may be a company such as Century 21.

In an alternate embodiment of the present invention the platform may also optionally create a branded agent detail page for the user. Said page would be automatically populated with personal information and consumer content videos.

The previously described versions of the present invention have many advantages, including and without limitation, the properties of i) functionality to brand the video to the user with assets such as video pre-roll, post-roll, changeable color scheme, and personal information, such as head-shot, logos, and contact information, ii) the ability for the user to share resultant video content on the user's detail, social media, or other websites, and iii) a delivery method for branded video newsletters specific to the user for marketing purposes such as sharing content and driving traffic to agent affiliated websites.

The device of the present invention is believed to accomplish all of the foregoing objectives. The invention does not require that all the advantageous features and all the advantages need to be incorporated into every embodiment of the invention.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A multi-component marketing platform for the production of combination video packages with branded market videos and professionally produced consumer content comprising:
a) a system asset pre-production phase;
b) a user registration phase following the system asset pre-production phase;
c) a system validation phase following the user registration phase;
d) a user parameter entry phase following the system validation phase;
e) a system video production phase following the user parameter entry phase; and
a user acceptance and use phase following the system video production phase.

2. The invention as in claim 1, where the system asset pre-production phase further comprises:
a) an asset creation process, which includes a video asset production sub-process and an audio asset production sub-process,
said video asset production sub-process includes shooting a plurality of videos and creation of a plurality of computer generated video assets that relate to various professional markets, for example shooting video relating home sales for use by users who are real estate agents, said audio asset production sub-process includes recording a plurality of scripted narrative and non-narrative audio files having a variety of data and conclusion options; and
b) an asset storage database for receipt and storage of the video and audio assets for later use.

3. The invention as in claim 1, where the user registration phase further comprises:
a) a user registration process,
said user registration process involving the user providing identifying information including email address and password to create an account in the system,
this identifying information further used by the user to log onto and manage the account thereafter; and
b) a user credential input process following the user registration process,
said user credential process involving the user providing identifying credentials that are specific to her professional field, for example entering MLS membership and ID in the case of a real estate agent.

4. The invention as in claim 1, where the system validation phase further comprises:
a) a credentials valid determination, wherein the identifying credentials provided by the user are validated by the system utilizing a protocol such as AJAX asynchronous JavaScript to query a public database to verify validity of said credentials, for example MLS membership and ID in the case of a real estate agent; and
b) a display approval message to user process following the credentials valid determination, if the result is affirmative.

5. The invention as in claim 1, where the system validation phase further comprises:
a) a credentials valid determination, wherein the identifying credentials provided by the user are validated by the system utilizing a protocol such as AJAX asynchronous JavaScript to query a public database to verify validity of said credentials, for example MLS membership and ID in the case of a real estate agent; and
b) a display error message to the user process following the credentials valid determination, if the result is negative and returning the user to the user credential input process of the user registration phase to re-enter credentials.

6. The invention as in claim 1, where the user parameter entry phase further comprises:
a) a user service area selection entry process,
said user service area selection entry process involving the user selection a professional practice area of which they desire the resultant video content to include, for example home sale and market news in the case of a real estate agent; and
b) a user contact and branding info entry process following the user service area selection entry process,
said user contact and branding info entry process involving the user entering the contact information that is desired to be incorporated into the resultant video which may include name, phone number, email, and accreditations,
said user contact and branding info entry process also involving the user uploading photos and branding images such as logos for incorporation into the resultant video.

7. The invention in claim 1, where the system video production phase further comprises a video assembly and production process involving retrieving the data, video and audio assets from the asset storage database in the system asset pre-production phase of the current invention, and then merging the assets with the user provided information from the user parameter entry phase to create a branded market video with professionally produced consumer content.

8. The invention as in claim 1, where the user acceptance and use phase further comprises:
a) a user video preview and subscription purchase process,
said user video preview and subscription purchase process involving the user previewing the resultant video;
b) a user payment processing process following the user video preview and subscription purchase process,
said user payment processing process involving the user providing payment information such as credit card information,
said payment information is processed by a secure third party billing service; and
c) a user account management process following the user payment processing process,
said user account management process involving optionally updating account information, sending newletters, obtaining embed codes or links for videos, and download leads captured by the system for her use.

9. The invention as in claim 2, where the system asset pre-production phase further comprises a video asset color variance production process where video assets colors can be changed prior to video assembly and production according to the user selected preferences in the user parameter entry phase.

10. The invention as in claim 8, where the user payment processing process further allows the user to select a plurality of videos and subscription services.

11. The invention as in claim 8, wherein the user acceptance and use phase further comprises a branded newsletter generation and dissemination process following the user account management process,
said branded newsletter generation and dissemination process allowing the user to send branded newsletters to a target recipient list.

12. The invention as in claim 8, wherein the user acceptance and use phase further comprises a branded user detail page generation process following the user account management process, said branded user detail page generation process creating a page that is automatically populated with the user's personal information and consumer content videos.
